(19) United States
(12) Patent Application Publication
(10) Pub. No.: US 2026/0195625 A1
(43) Pub. Date: Jul. 9, 2026

(54) QUANTUM COMPUTING SYSTEMS WITH SUPERCONDUCTING QUANTUM BIT CIRCUITRY AND SPATIALLY DISTRIBUTED HYBRID CRYOGENIC ELECTRONIC CONTROL ARCHITECTURE

(71) Applicant: SeeQC, Inc., Elmsford, NY (US)

(72) Inventors: Shu-Jen Han, Armonk, NY (US); Remus Albu, New York City, NY (US); Caleb Jordan, Peekskill, NY (US)

(21) Appl. No.: 19/014,056

(22) Filed: Jan. 8, 2025

(51) Int. Cl. G06N 10/20

(52) U.S. Cl. CPC G06N 10/20

(57) ABSTRACT

A system for implementing a hybrid cryogenic electronic architecture is disclosed. The system comprises: a cryostat system operable to provide a first cryogenic temperature and a second cryogenic temperature; a quantum computing module comprising a plurality of quantum bit circuits capable of superconducting at the first cryogenic temperature; a CMOS circuitry module enclosed by the cryostat at the second cryogenic temperature and structured to support complementary metal-oxide-semiconductor (CMOS) circuits configured to interface with SFQ logic circuitry to allow control signals and quantum bit signals to be transferred therebetween; and an ambient temperature or room temperature (RT) control module operable to provide input signals to the CMOS circuitry module and to receive therefrom readout signals associated with quantum states of the plurality of quantum bit circuits.

### TECHNICAL FIELD

This patent document relates to computing or information processing systems including quantum computing modules performing classical information processing or computing using quantum states of quantum mechanical devices or circuits.

### BACKGROUND

Quantum-mechanical systems can be used to construct computation systems for complex information processing. A quantum system suitable for quantum computing has an ensemble of subsystems exhibiting different quantum states including subsystems which are correlated and “entangled” with one another. In various implementations of quantum computers, each subsystem in the ensemble of subsystems may be a quantum system exhibiting two or more different quantum states to operate as a quantum bit (“qubit”) and information can be represented, stored, processed, and transmitted to different qubits.

### SUMMARY

The technology disclosed in this patent document can be implemented to provide a spatially distributed hybrid cryogenic electronic control architecture based on complementary metal-oxide-semiconductor (CMOS) technology where CMOS circuitry and CMOS memory are partially included in a cryogenic electronic control module adjacent to quantum bit circuits by using single flux quantum (SFQ) circuitry based on superconducting Josephson junctions to interface between the quantum bit circuits and the CMOS circuitry, thereby reducing CMOS processing at room temperature and associated complex communication traffics between the quantum computing module and the CMOS processing module. Some architectures disclosed herein provide qubit control by integrating cryogenic CMOS (cryo-CMOS) circuit modules operating at the 4 K stage of a dilution refrigerator and SFQ circuit modules operating at the millikelvin (mK) stage of the dilution refrigerator. Such integration schemes enable certain circuit functions of the SFQ circuit modules to be offloaded to the cryo-CMOS circuit modules such that the cooling power from both the mK and 4 K stages can be leveraged, thereby allowing quantum computing systems based on the disclosed technology to support a large number of qubits at the mK stage. The disclosed architectures also leverage the high maturity of CMOS fabrication techniques, which lowers the risk of low manufacturing yield of SFQ circuitry. Furthermore, memory technology is readily available to cryo-CMOS technologies and can be implemented to provide all required on-die digital programming capabilities.

In one aspect, the disclosed technology can be implemented to provide a system for implementing a hybrid cryogenic electronic architecture to perform information processing based at least in part on computing using quantum states of quantum bits. This system in one implementation can include a cryostat system structured to include different cryogenic stages including first and second cryogenic stages operable to provide, respectively, a first cryogenic temperature and a second cryogenic temperature higher than the first cryogenic temperature; a quantum computing module enclosed by the first cryogenic stage of the cryostat system at the first cryogenic temperature, the quantum computing module comprising a plurality of quantum bit circuits capable of superconducting and operating to perform quantum operations at the first cryogenic temperature; a single flux quantum (SFQ) logic circuitry enclosed by the first cryogenic stage of the cryostat system at the first cryogenic temperature and coupled to the plurality of quantum bit circuits to provide control signals to and to receive quantum bit signals from the plurality of quantum bit circuits; a CMOS circuitry module enclosed by the second cryogenic stage of the cryostat system at the second cryogenic temperature and structured to support complementary metal-oxide-semiconductor (CMOS) circuits configured to interface with the SFQ logic circuitry to allow the control signals and quantum bit signals to be transferred therebetween; and a room temperature (RT) control module located external to the cryostat system and configured to beoperable to provide input signals to the CMOS circuitry module and to receive therefrom readout signals associated with quantum states of the plurality of quantum bit circuits. The RT control module is configured to include one or more computer processors to provide the input signals to the CMOS circuitry module and to process readout signals associated with quantum states of the plurality of quantum bit circuits.

This and other aspects, and their implementations are described in greater detail in the drawings, the description and the claims.

### BRIEF DESCRIPTION OF THE DRAWINGS

FIG. 1 shows an example block diagram of a system that can be implemented as part of a quantum computing system that is separate from quantum bits based on the disclosed technology.

FIG. 2 shows another example block diagram of a system that can be implemented between the system in FIG. 1 and the quantum bits as part of a quantum computing system based on the disclosed technology.

FIG. 3 shows yet another example block diagram of an SFQ quantum bit control system that includes quantum bit circuits and can be implemented as part of a quantum computing system based on the disclosed technology.

FIG. 4 shows an example block diagram of a quantum computing system and interconnection designs to connect various hardware therein in accordance with some embodiments of the disclosed technology.

FIG. 5 shows example plots of signals that can be transferred between a CMOS system and an SFQ system in accordance with some embodiments of the disclosed technology.

FIG. 6 shows an example schematic of an interface between a cryo-CMOS system controller and an SFQ quantum computing controller in accordance with some embodiments of the disclosed technology.

### DETAILED DESCRIPTION

Various architectures exist for quantum computing, including, for example, superconducting quantum computers that rely on a brute-force scaling approach where a quantum chip operating at the millikelvin temperature stage inside a dilution refrigerator (DR) is connected to electronics at or near the local ambient temperature or the room temperature (RT) outside the dilution refrigerator via various signal wires. Various implementations of such supercomputers may have several limitations including, among others: (i) requiring numerous racks of complex RT electronics outside the dilution refrigerator for operation, (ii) the finite cooling capacity of the dilution refrigerator to remove the heat generated from enormous numbers of wires and analog components such as attenuators, (iii) the insufficient space inside the dilution refrigerator to accommodate these wires and components, and (iv) the tremendous footprint and energy consumption of RT electronics and dilution refrigerators.

Various methods to address such limitations include inserting complementary metal-oxide-semiconductor (CMOS) based mixed-signal control electronics at cryogenic temperature into quantum computing architectures without significantly deviating from the conventional RT control scheme which relies on generating high-quality shaped microwave pulses. As a result, such methods may tend to be ineffective in addressing the above limitations. In addition, the high complexity of such control circuits with high transistor counts and the relatively high power consumption of CMOS transistor technology make it difficult to keep such architectures at the 4 K stage and this limitation renders it necessary to use conductions between a quantum chip at the 20 mK stage and control circuits at a higher temperature of 4K using ultra high-density superconducting cables. The presence of using superconducting cables creates an input/output (I/O) overhead bottleneck. Furthermore, the demonstrated power consumption of such architectures tends to be relatively high, e.g., around 4 mW/qubit in some designs, which is orders of magnitude higher than the allowable heat dissipation of many cryostat at 4 K (~2 W) for architectures with over 100,000 physical qubits for various practical quantum computing applications.

Other attempts to address the aforementioned limitations include superconducting electronics such as energy-efficient rapid single flux quantum (ERSFQ) circuits which can be used for building ultra-low power control electronics for qubits. Although such low power electronics can be operated at qubit temperatures (10-20 mK) and integrated with quantum chips, various proposed implementations still pose several technical limitations, including: (i) the cooling power at the mK stage is significantly less than the 4 K stage, which limits the single flux quantum (SFQ) circuit complexity, (ii) the maturity of SFQ manufacturing is much lower than CMOS, and (iii) the lack of a proper memory solution in SFQ.

The disclosed technology in this application includes hybrid cryogenic electronic control architectures which, among other features and benefits, can be implemented in computing or information processing systems to address the above limitations.

The technology disclosed herein relates to hybrid cryogenic electronic architectures for computing or information processing systems with superconductor-based quantum computing modules (e.g., superconducting Josephson junctions). Some embodiments of the disclosed technology include systems which integrate cryo-CMOS technology and SFQ circuitry in ways that allow the SFQ circuitry to interface with quantum bit circuits operating at a low cryogenic temperature (~0.01 K) and with cryogenic CMOS circuitry operating at a higher cryogenic temperature (~4 K) to reduce CMOS processing operations at room temperature.

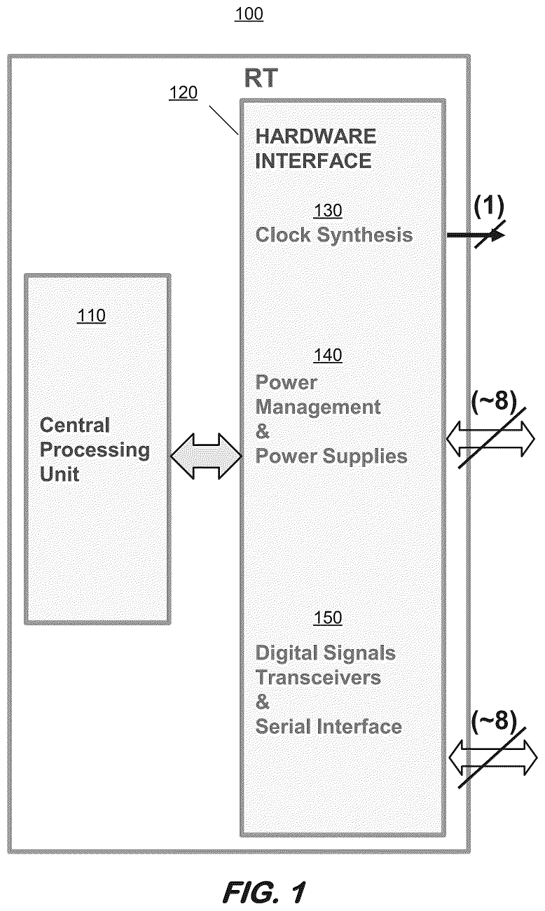

FIGS. 1, 2, and 3 show examples of block diagrams for implementing quantum computing systems based on the disclosed technology and interconnection designs for connecting different hardware modules within a multistage dilution refrigerator system.

FIG. 1 shows an example of a system 100 that can be implemented as part of a quantum computing system that is separate from the quantum bits based on the disclosed technology. The system 100 is located at or near the room temperature (RT) and includes a classic central processing unit (CPU) 110 and a CPU hardware interface 120 (e.g., PCI, VXI) to enable interfacing between the RT system 100 and a cryo-CMOS system located at a cryogenic stage (e.g., 4 K) of a dilution refrigerator containing quantum bit circuits in communication with the cryo-CMOS system. The CPU 110 and hardware interface 120 are configured to communicate with one another and to transmit and receive signals therebetween. The CPU 110 may operate as part of a computer or server configured to run software which drives specific features of the hardware interface 120 and to process signals in connection with instructions for performing quantum computing operations by the quantum bits and to process the results from the quantum computing operations for a user. For example, the CPU 110 may provide or process signals related to qualifying/characterizing each of the quantum bits, initializing the state of the quantum bits to a fiducial state, measuring and monitoring relevant quantum coherence times, configuring a universal set of quantum gates, and configuring measurement capabilities of specific quantum bits. The hardware interface 120 comprises various pieces of equipment which can be implemented to transmit signals to the cryo-CMOS system and to receive signals therefrom. In various implementations, the classic central processing unit (CPU) 110 may include one or more digital processors or/and additional digital processors in communications with the one or more digital processors via communication links. The CPU 110, with the one or more digital processors or/and the additional digital processors, serves as a physical layer for real-time bidirectional access to the quantum computing system. For example, the CPU 110, with the one or more digital processors or/and the additional digital processors, can control signals provided to the quantum computing system and provide the real-time status of the quantum computing system.

In the specific example shown in FIG. 1, the hardware interface 120 includes a clock synthesis module 130, power management and power supplies 140, as well as digital signal transceivers and a serial interface 150. The clock synthesis module 130, the power management and power supplies 140, and the digital signal transceivers and serial interface 150 may be configured into one or more modules that operate within the hardware interface 120. The clock synthesis module 130 is operable to generate a stable frequency signal required at an input of a cryo-CMOS clock synthesis module that operates as part of the cryo-CMOS system. The power management and power supplies 140 can be implemented to provide the cryo-CMOS system with the necessary power to facilitate its operations. For example, the power management and power supplies 140 are operable to manage and control power levels, power sequences, and power resets for the cryo-CMOS system. The digital signal transceivers and the serial interface 150 can be implemented to provide serial data streaming for programming and controlling the cryo-CMOS system. Data (e.g., serial data and handshake data) received by the hardware interface 120 from the cryo-CMOS system can be readout via the serial interface.

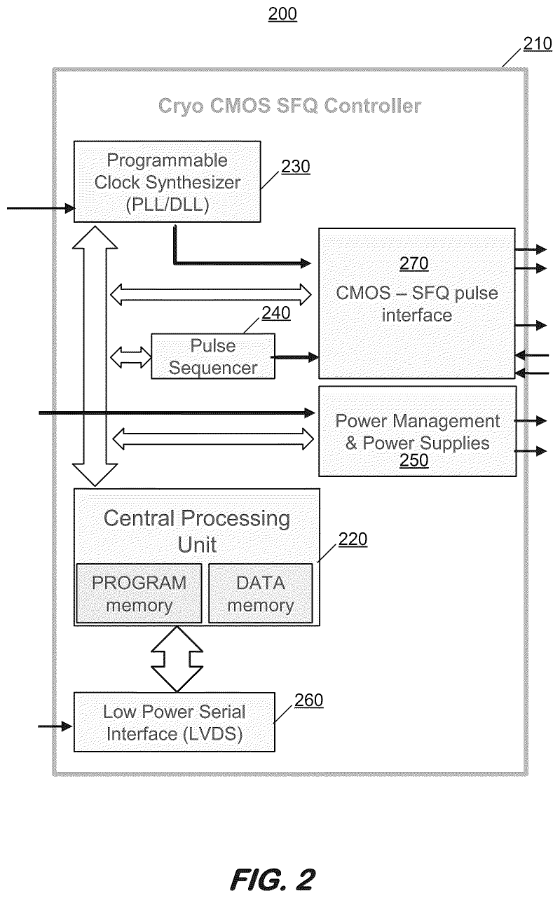

FIG. 2 shows an example of a cryo-CMOS system 200 that can be implemented between the system 100 with CPU in FIG. 1 and the quantum bits as part of a quantum computing system based on the disclosed technology. The cryo-CMOS system 200 may be located within a dilution refrigerator and operated in a cryogenic stage (e.g., ~4 K) of the dilution refrigerator. The cryo-CMOS system 200 includes a cryo-CMOS SFQ controller 210. In some implementations, the cryo-CMOS system 200 is in communication with the system 100 located at RT such that data to facilitate operations of the quantum computing system may be transferred between the cryo-CMOS system 200 and the RT system 100. The cryo-CMOS system 200 is configured to interface with an SFQ quantum bit control system located in a lower temperature cryogenic stage (e.g., ~0.01 K) of the dilution refrigerator and structured to include quantum bit circuits for performing quantum-based computing. The cryo-CMOS SFQ controller 210 includes a CPU 220, operable as part of a computer or server, configured to run software to control functionalities of the cryo-CMOS system 200 and the various hardware interfaces included therein. The CPU 220 is configured to communicate via a data bus (e.g., a tri-state bus) with additional devices included in the cryo-CMOS SFQ controller 210 which include the programmable clock synthesizer 230, the pulse sequencer 240, the CMOS-SFQ pulse interface 270, and the power management and power supplies 250. Each of the programmable clock synthesizer 230, the pulse sequencer 240, the CMOS-SFQ pulse interface 270, and the power management and power supplies 250 may be connected to the CPU 220 via the data bus and addressed and controlled under supervision by the CPU 220.

In some implementations, the programmable clock synthesizer 230, the pulse sequencer 240, the CMOS-SFQ pulse interface 270, and the power management and power supplies 250 may be controlled based on time domain slots. As shown in FIG. 2, the CPU 220 also includes program memory and data memory which may be stored in a random-access memory (RAM) device in communication with the CPU 220. The program memory may be loaded via the low-power serial interface 260 and the data memory may be written and/or read by the CPU 220 or the low-power serial interface 260. In some implementations, the low-power serial interface 260 is a standard CMOS low-power serial interface (e.g., low-voltage differential signaling (LVDS)) configured to interface with the CPU 220 using a serial communication protocol (e.g., Universal Serial Bus (USB) or Internet Protocol Connectivity Access Network (IP-CAN)). The programmable clock synthesizer 230 may include one or more CMOS clock synchronization circuits (e.g., phase-locked loops or delay-locked loops) locked to a signal received at an input of the cryo-CMOS SFQ controller 210 from RT electronics such as the RT system 100. In some implementations, the signal received at the input of the cryo-CMOS SFQ controller 210 is generated by the clock synthesis module 130. In some implementations, the cryo-CMOS system 200 is structured to interface with an SFQ quantum bit control system comprising an array of quantum bits and the programmable clock synthesizer 230 may dynamically generate one or more frequency signals to control the array of quantum bits. The frequency signals generated by the programmable clock synthesizer 230 may be scaled by the CMOS-SFQ pulse interface 270. The cryo-CMOS SFQ controller includes various SFQ circuits which may be programmed by the pulse sequencer 240. For example, the pulse sequencer 240 may provide a times series of pulses to program (e.g., serially) the SFQ circuits. Programming of the SFQ circuits by the pulse sequencer 240 may involve demultiplexing addresses, counters, and/or registers. Signals generated by the pulse sequencer 240, such as the time series of pulses, may be scaled by the CMOS-SFQ pulse interface 270. In some implementations, the power management and power supplies 250 are configured to provide a time series of pulses (e.g., in the form of electrical current) to bias an SFQ quantum bit controller which may be included as part of an SFQ quantum bit control system interfacing with the cryo-CMOS system 200. For example, the SFQ quantum bit controller may include programmable counters and a demultiplexing module to demultiplex signals in the SFQ quantum bit control system. In some operations, the demultiplexing module needs to be biased and then shut off, while the programmable counters need to be biased and operate at a clock frequency provided by the programmable clock synthesizer 230. Such biasing of the demultiplexing and the programmable counters can be achieved using the power management and power supplies 250.

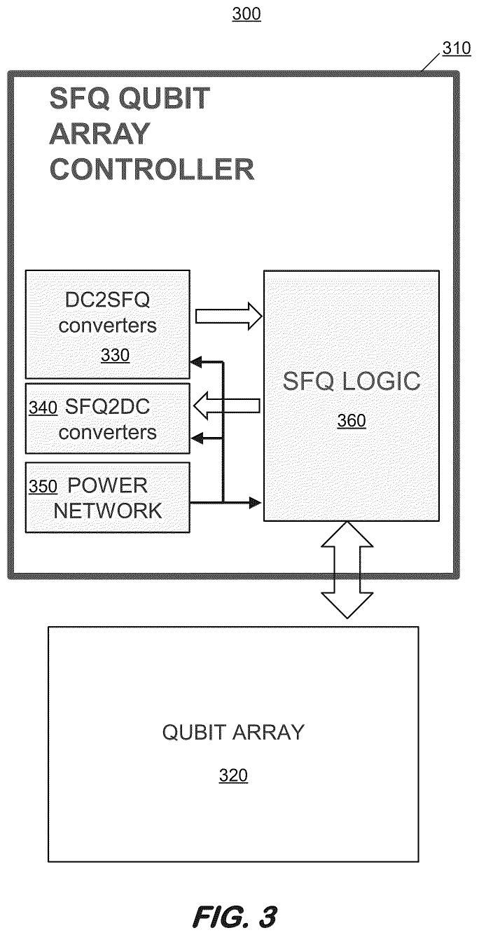

FIG. 3 shows an example of an SFQ quantum bit control system 300 that can be implemented as part of a quantum computing system based on the disclosed technology. The SFQ quantum bit control system 300 includes an array of quantum bit circuits 320 as the heart of the quantum computing and quantum bit control circuits that interface with the array of quantum bit circuits 320 to provide communications and signaling between the array of quantum bit circuits 320 and the cryo-CMOS system 200 in FIG. 2.

In some implementations, the SFQ quantum bit control system 300 is located within a dilution refrigerator and operated in a low-temperature cryogenic stage (e.g., ~0.01 K) of the dilution refrigerator, the low-temperature cryogenic stage capable of achieving cryogenic temperatures in the milli Kelvin range. Cryo-CMOS technology such as the cryo-CMOS system 200, operating within the dilution refrigerator at temperatures higher than the low-temperature cryogenic stage (e.g., ~4 K), is configured to interface with the SFQ quantum bit control system 300, operating at the low-temperature cryogenic stage (e.g., ~0.01 K), to allow signals to be transferred between the cryo-CMOS system 200 and the SFQ quantum bit control system 300. The SFQ quantum bit control system 300 includes the array of quantum bit circuits 320 to perform quantum computing operations based on quantum states of quantum bits included in the array. The SFQ quantum bit control system 300 includes the SFQ quantum bit array controller 310. The SFQ quantum bit array controller 310 includes the quantum bit circuits which are structured as the array of quantum bit circuits 320. In some implementations, the array of quantum bit circuits 320 is supported by additional devices and structures included in the array of quantum bit circuits 320. The SFQ quantum bit array controller 310 may be implemented to direct operations of the SFQ quantum bit control system 300 such as readout and control operations relating to the quantum bit circuits.

The SFQ quantum bit array controller 310 comprises quantum bit control circuits including SFQ circuits comprising one or more DC2SFQ convertors 330 and one or more SFQ2DC convertors 340. The one or more DC2SFQ convertors 330 are configured to convert cryo-CMOS time series signals, such as time series signals generated by the pulse sequencer 240 or the programmable clock synthesizer 230, into SFQ pulses and output the SFQ pulses to the SFQ logic circuitry 360. The one or more SFQ2DC convertors 340 are configured to convert SFQ time series signals to time series voltage pulses (e.g., ~200 microvolts). In some implementations, the one or more SFQ2DC convertors 340 are structured to transmit the voltage pulses to the CMOS-SFQ pulse interface 270 via a transmission line (e.g., a 50 Ohm impedance line). In some implementations, the one or more DC2SFQ convertors 330 are configured to receive the cryo-CMOS time series signals via a transmission line (e.g., a 50 Ohm impedance line).

The SFQ quantum bit array controller 310 also includes the power network 350 which interfaces with the SFQ logic circuitry 360 and the quantum bit controls circuits (e.g., the one or more DC2SFQ convertors 330 and the one or more SFQ2DC convertors 340) to provide and distribute power to the SFQ logic circuitry 360 and the quantum bit control circuits as needed to perform SFQ circuit operations. The SFQ logic circuitry 360, which may include multiple SFQ logic circuits, is configured to control and readout the array of quantum bit circuits 320 using SFQ pulses. The SFQ logic circuitry 360 includes various functionalities to facilitate the control and readout operations, which include signal routing and signal distribution functionalities as well as SFQ-logic-based functionalities. The SFQ logic circuitry 360 is configured to receive SFQ pulses as input and provide SFQ pulses as output. For example, SFQ pulses from the one or more DC2SFQ convertors 330 may be received at an input of the SFQ logic circuitry 360 and SFQ pulses generated by the SFQ logic circuitry 360 may be output by the SFQ logic circuitry 360 to the one or more SFQ2DC convertors 340. SFQ pulses may also be transmitted and received between the SFQ logic circuitry 360 and the array of quantum bit circuits 320.

The RT system 100, cryo-CMOS system 200, and the SFQ quantum bit control system 300 may be communicatively coupled to one another to perform information processing and computing operations based on quantum states of quantum bits as will be explained in further detail in the description that follows. In some example embodiments, the cryo-CMOS system 200 operating ~4 K is powered by RT sources included in the RT system 100 and the cryo-CMOS system 200 can receive signals such as input clock reference signals and digital I/O from the RT system 100 without the use of radio frequencies (RF). The cryo-CMOS SFQ controller 210, in some implementations, is structured on a cryo-CMOS chip which interfaces with an SFQ quantum bit array controller. For example, the SFQ quantum bit array controller, in some implementations, is structured on an SFQ quantum controller chip (e.g., system-on-chip format) and the cryo-CMOS chip is placed adjacent to the SFQ quantum controller chip operating at the milliKelvin quantum bit operating temperature (0.01 K). The cryo-CMOS chip is configured to manage power provided to the SFQ quantum controller chip and to provide digital I/O to the SFQ quantum controller chip based on SFQ-specific signal levels and protocols (e.g., low current single ended current sources, pulse time modulated, etc.). The integration of the cryo-CMOS chip (4 K) with the SFQ quantum controller chip (0.01 K) under this design scheme offers several advantages because the design (i) does not require an IQ modulator/demodulator, (ii) does not require RF signals to be transferred between the cryo-CMOS chip and the SFQ quantum controller chip, and (iii) enables heat loads to be shared between the cryo-CMOS chip and the SFQ quantum controller chip such that the SFQ quantum controller chip can support a large array of quantum bit circuits. Additionally, in some implementations, the cryo-CMOS chip interfaces with and is powered by a RT controller which operates using power lines, a reference clock line, and a low-power serial interface. Thus, RF signals are also not required to be transferred between the cryo-CMOS chip and the RT controller.

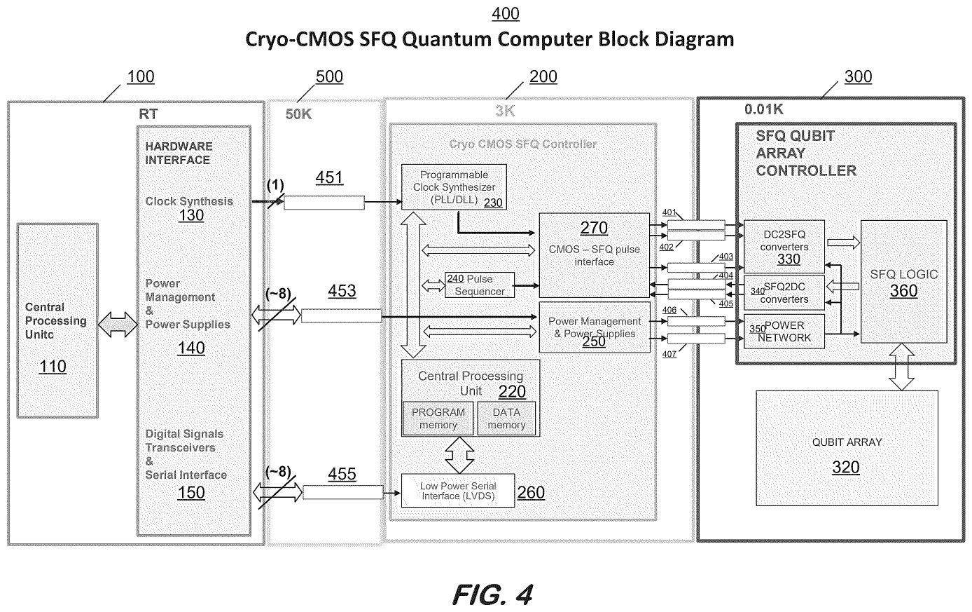

FIG. 4 shows an example block diagram of a cryo-CMOS SFQ quantum computing system 400 based on the disclosed technology. This system 400 includes the cryo-CMOS system 200, and the SFQ quantum bit control system 300 as previously described in connection to FIGS. 2-3 and an unrefrigerated ambient or room temperature RT system 100 with electronics and processors outside the low temperature cryogenic systems 500, 200 and 300 as different stages of a dilution refrigerator as illustrated in an example in FIG. 1. Portions of the cryo-CMOS SFQ quantum computing system 400, such as the cryo-CMOS system 200, the SFQ quantum bit control system 300, and the cryogenic system 500, may be located within different stages of a dilution refrigerator capable of achieving different cryogenic temperatures in the different stages while other portions of the cryo-CMOS SFQ quantum computing system 400 such as the RT system 100 may be located outside of the dilution refrigerator and operate at room temperature. In the example of FIG. 4, the SFQ quantum bit control system 300 operates within a low-temperature cryogenic stage (e.g., ~0.01 K) of the dilution refrigerator, the cryo-CMOS system 200 operates within a higher temperature cryogenic stage (e.g., ~4 K) of the dilution refrigerator than the SFQ quantum bit control system 300, the cryogenic system 500 operates within another cryogenic stage (e.g., ~50 K) of the dilution refrigerator which sits at higher cryogenic temperature than both the SFQ quantum bit control system 300 and the cryo-CMOS system 200, and the RT system 100 is located outside of the dilution refrigerator. The RT system 100, cryogenic system 500, cryo-CMOS system 200, and SFQ quantum bit control system 300—the SFQ quantum bit control system 300 comprising the array of quantum bit circuits 320—are communicatively coupled to one another. Thus, the cryo-CMOS SFQ quantum computing system 400 forms a hybrid cryogenic electronics architecture for quantum computing and information processing based on quantum states of quantum bits which integrates the cryo-CMOS system 200 at the ~4 K stage of the dilution refrigerator with the SFQ quantum bit control system 300 at the ~0.01 K stage inside of the dilution refrigerator.

In the example of FIG. 4, the cryogenic system 500 is implemented between the RT system 100 and the cryo-CMOS system 200 to enable interfacing between the RT system 100 and the cryo-CMOS system 200 and signal transfer therebetween. In some implementations, the temperature of the cryogenic system 500 is achieved using liquid nitrogen, the temperature of the cryo-CMOS system 200 is achieved using liquid He, and the cryogenic system 500 serves to thermally insulate the RT system 100 from the cryo-CMOS system 200. Interfacing between the RT system 100 and the cryo-CMOS system 200 may be facilitated via signal-carrying transmission lines through which signals can be transferred between the RT system 100 and the cryo-CMOS system 200. For example, interfacing between the clock synthesis module 130 and the programmable clock synthesizer 230, the power management and power supplies 140 and the power management and power supplies 250, and the digital signals transceivers and serial interface module 150 and the low-power serial interface 260 are conducted via the signal-carrying transmission lines 451, 453, and 455, respectively, that are maintained in another cryogenic stage at a temperature (e.g., 50K) that is below the room temperature and higher than the cryogenic temperature of the cryo-CMOS system 200 (e.g., 3 K). Additional signal-carrying transmission lines 451, 453, and 455 may also be used to facilitate signal transfer between the cryo-CMOS system 200 and the SFQ quantum bit control system 300. For example, interfacing between the CMOS-SFQ pulse interface 270 and the DC2SFQ convertors 330, the CMOS-SFQ pulse interface 270 and the SFQ2DC convertors 340, and the power management and power supplies 250 and the power network 350 is facilitated, respectively, using the signal-carrying lines 401, 402, and 403, the signal-carrying transmission lines 404 and 405, and the signal-carrying transmission lines 406 and 407. Other example interconnection designs between the various components and systems included in the cryo-CMOS SFQ quantum computing system 400 are depicted in FIG. 4 using arrows. As previously described in connection to FIGS. 1-3 and shown in FIG. 4, the RT system 100 may include a CPU 110; the cryo-CMOS system 200 may include a pulse sequencer 240, a programmable clock synthesizer 230, and a CPU 220; and the SFQ quantum bit control system 300 may include SFQ logic circuitry 360. In some implementations, the RT system 100, the cryo-CMOS system 200, and the SFQ quantum bit control system 300 may perform the respective operations and functions previously described in connection to FIGS. 1-3. The cryo-CMOS SFQ quantum computing system 400 may be configured into various modules for performing the respective operations and functions. In some implementations, the RT system 100 and the cryo-CMOS system 200 are configured to communicate without the use of an in-phase/quadrature-phase (IQ) modulator or demodulator.

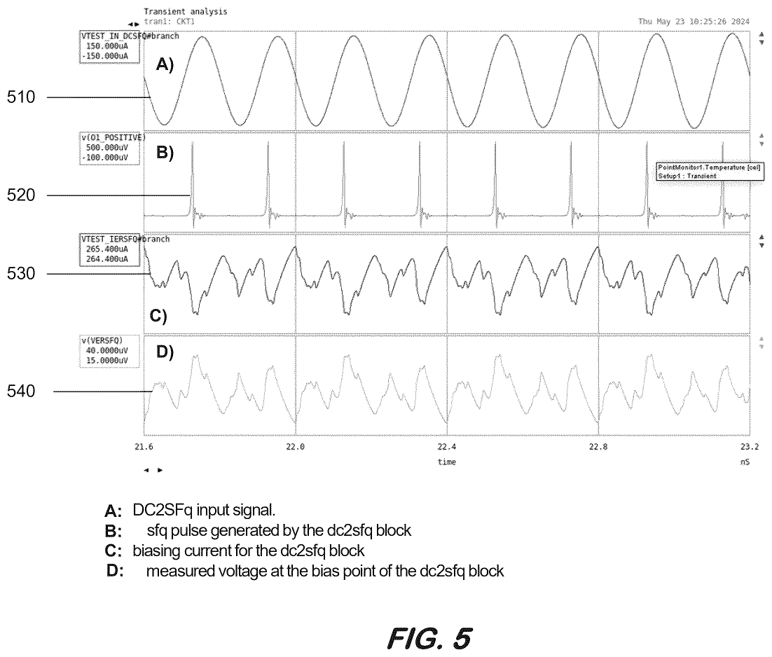

FIG. 5 shows examples of various signals that can be transferred between CMOS and SFQ systems based on the disclosed technology. FIG. 5 includes an example of a CMOS signal 510 which may be received at an input of a DC2SFQ convertor, an example of an SFQ pulse 520 which may be generated by a DC2SFQ convertor, an example of current waveform 530 which may be used to bias a DC2SFQ convertor, and an example of a voltage signal 540 measured at a biasing point of a DC2SFQ convertor. The DC2SFQ convertor may correspond to the one or more DC2SFQ convertors 330 shown in FIGS. 3 and 4. Input and output signals may be transferred between cryo-CMOS and SFQ systems. In some implementations, the input signals are current pulses which return to zero. In some implementations, the input signals have peak-to-peak amplitudes between approximately 80 microamps to 200 microamps and rise/fall times of approximately 50 picoseconds. In some implementations, the output signals are voltage pulses which return to zero. In some implementations, the output signals have peak-to-peak amplitudes of approximately 100 microvolts and rise/fall times of approximately 5 picoseconds.

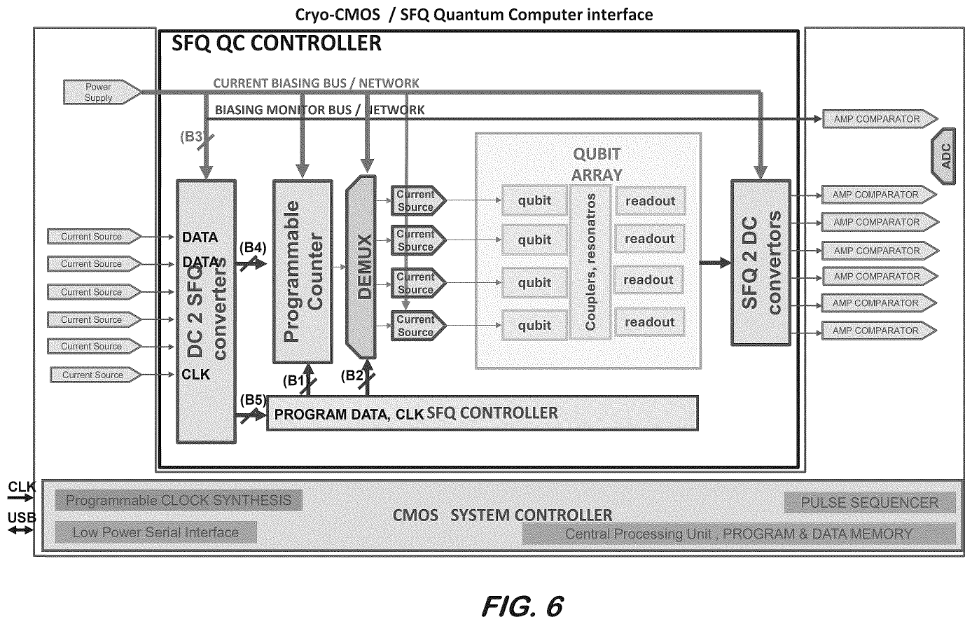

FIG. 6 shows an example schematic of an interface between a CMOS system controller (e.g., the cryo-CMOS SFQ controller 210) and an SFQ quantum computing controller (e.g., the SFQ quantum bit array controller 310). As shown in FIG. 6, the CMOS system controller includes a programmable clock synthesizer, a low-power serial interface, a CPU comprising program and data memory, a pulse sequencer, one or more amperage comparators, an analog-to-digital convertor (ADC), a power supply, and one or more current sources. The SFQ quantum computing controller includes DC2SFQ convertors, a programmable counter, a demultiplexer, an array of quantum bit circuits, SFQ2DC convertors, a current biasing bus, a biasing monitor bus, and multiple current sources. The array of quantum bit circuits includes multiple qubits and resonators. The resonators are coupled to quantum bits in the array such that quantum states of the quantum bits may be read out via the resonators. In some implementations, the array of quantum bit circuits includes inter-quantum bit couplers to facilitate interactions between quantum bits.

The CMOS system controller is configured to transmit power to the SFQ quantum computing controller via a current biasing bus which is structured to distribute the power to some or all of the DC2SFQ convertors, the programmable counter, the demultiplexer, the current sources, and the SFQ2DC convertors within the SFQ quantum computing controller. The current biasing bus is monitored by the biasing monitor bus which is configured to send monitoring data related to the current biasing to an amperage comparator in communication with the CMOS system controller. Inputs of the DC2SFQ converters may receive current (e.g., DC current) from various current sources provided by the CMOS system controller and the DC2SFQ convertors may convert the received current into SFQ pulses which are output to the programmable counter. The SFQ pulses may be counted by the programmable counter and transmitted to the demultiplexer which is configured to demultiplex the SFQ pulses according to timing information received from the SFQ quantum controller such that specific SFQ pulses are transmitted to specific quantum bits in the array of quantum bit circuits. The array of quantum bits is in communication with SFQ2DC convertors which are configured to convert readout SFQ signals received by the SFQ2DC convertors from the readout circuits in the array of quantum bits into voltage pulses. The voltage pulses from the SFQ2DC convertors may be received by amperage comparators and transmitted to an analog-to-digital convertor (ADC) to convert the voltage pulses into a digital signal containing information about the quantum states of the quantum bits.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few implementations and examples are described and other implementations, enhancements and variations can be made based on what is described and illustrated in this patent document.

What is claimed is what is disclosed and/or illustrated, including:

1. A system for implementing a hybrid cryogenic electronic architecture to perform information processing based at least in part on computing using quantum states of quantum bits, the system comprising:
a cryostat system structured to include different cryogenic stages including first and second cryogenic stages operable to provide, respectively, a first cryogenic temperature and a second cryogenic temperature higher than the first cryogenic temperature;
a quantum computing module enclosed by the first cryogenic stage of the cryostat system at the first cryogenic temperature, the quantum computing module comprising a plurality of quantum bit circuits capable of superconducting and operating to perform quantum operations at the first cryogenic temperature;
a single flux quantum (SFQ) logic circuitry enclosed by the first cryogenic stage of the cryostat system at the first cryogenic temperature and coupled to the plurality of quantum bit circuits to provide control signals to and to receive quantum bit signals from the plurality of quantum bit circuits;
a CMOS circuitry module enclosed by the second cryogenic stage of the cryostat system at the second cryogenic temperature and structured to support complementary metal-oxide-semiconductor (CMOS) circuits configured to interface with the SFQ logic circuitry to allow the control signals and quantum bit signals to be transferred therebetween; and
a room temperature (RT) control module located external to the cryostat system and configured to be operable to provide input signals to the CMOS circuitry module and to receive therefrom readout signals associated with quantum states of the plurality of quantum bit circuits, wherein the RT control module includes one or more computer processors to provide the input signals to the CMOS circuitry module and to process readout signals associated with quantum states of the plurality of quantum bit circuits.

2. The system of claim 1, wherein the RT control module comprises:
a reference clock operable to generate one or more frequency signals;
sources configured to output power signals; and
one or more transceivers in communication with a serial interface, the one or more transceivers configured to transmit and receive digital signals using the serial interface.

3. The system of claim 2, wherein the input signals comprise one or more of the digital signals, the power signals, or the one or more frequency signals.

4. The system of claim 1, wherein CMOS circuitry module further comprises:
a programmable clock synthesizer configured to receive at least one of the input signals and to generate one or more frequency signals based on the at least one of the input signals;
a pulse sequencer configured to generate a time series of pulses to program the SFQ logic circuitry; and
an interface operable to scale the one or more frequency signals and the time series of pulses and to direct the one or more frequency signals and the time series of pulses to the quantum computing module.

5. The system of claim 4, wherein the one or more frequency signals are generated based on a phase-locked loop or a delay-locked loop, wherein the phase-locked loop or the delay-locked loop locks to the at least one of the input signals.

6. The system of claim 1, wherein the CMOS circuitry module further comprises one or more power supplies configured to provide a time series of current pulses to the quantum computing module based on at least one of the input signals.

7. The system of claim 1, the wherein CMOS circuitry module further comprises:
a low-power serial interface in communication with the RT module; and
a central processing unit (CPU) configured to execute software that controls hardware included in the CMOS circuitry module, the CPU comprising program memory and data memory,
wherein the program memory is loaded via the low-power serial interface,
wherein the data memory is writable and readable by the CPU.

8. The system of claim 7, wherein the low-power serial interface is in communications with the CPU using a serial communication protocol, wherein the serial communication protocol comprises a universal serial bus (USB) protocol or Internet Protocol Connectivity Access Network (IP-CAN) protocol.

9. The system of claim 1, wherein the RT control module and the CMOS circuitry module are configured to communicate without the use of radio frequency (RF) signals.

10. The system of claim 1, wherein the RT control module and the CMOS circuitry module are configured to communicate without the use of an in-phase/quadrature-phase (IQ) modulator or demodulator.

11. The system of claim 1, wherein the SFQ logic circuitryincludes:
a first SFQ circuit configured to receive time-series signals and convert the time-series signals into SFQ pulses; and
a second SFQ circuit configured to receive the SFQ pulses from an output of the first SFQ circuit, the second SFQ circuit further configured to input the SFQ pulses to the quantum bit circuits and to receive SFQ pulses therefrom which contain information related to the quantum states of quantum bits included in the quantum bit circuits.

12. The system of claim 1, wherein the SFQ logic circuitry includes a plurality of convertors and a plurality of SFQ circuits, wherein the plurality of convertors includes at least one convertor configured to convert SFQ time-series signals received from at least one of the plurality of SFQ circuits into voltage pulses which are outputted to the CMOS circuitry module.

13. The system of claim 1, wherein the quantum computing module includes a power network configured to receive the at least some of the input signals and distribute the at least some of the input signals to the SFQ logic circuitry.

14. The system of claim 1, wherein the readout signals are based on a response by the quantum bit circuits to SFQ pulses received from the SFQ logic circuitry.

15. The system of claim 1, wherein the quantum computing module further comprises a plurality of readout resonators structured to interact, respectively, with the plurality of quantum bit circuits to produce the readout signals.

16. The system of claim 1, further comprising a plurality of signal carrying lines, wherein the CMOS circuits are configured to interface with the SFQ logic circuitry using at least some of the plurality of signal carrying lines.

17. The system of claim 1, wherein the SFQ circuitry includes a superconducting Josephson junction.

18. The system of claim 1, wherein the cryostat system is structured to include a third cryogenic stage operable to provide a third cryogenic temperature higher than the second cryogenic temperature, wherein the system further comprises conductive channels enclosed in the third cryogenic stage operable at the third cryogenic temperature and configured to facilitate signal communications between the RT module and the CMOS circuitry module.

19. The system of claim 18, wherein the first cryogenic temperature is approximately 0.01 K, the second cryogenic temperature is approximately 4 K, and the third cryogenic temperature is approximately 50 K.

20. The system of claim 1, wherein the first cryogenic temperature is approximately 0.01 K and the second cryogenic temperature is approximately 4 K.
